(19) United States
(12) Patent Application Publication
(10) Pub. No.: US 2021/0323066 A1
(43) Pub. Date: Oct. 21, 2021

(54) MATERIAL SETS

(71) Applicant: HEWLETT-PACKARD DEVELOPMENT COMPANY, L.P., Spring, TX (US)

(72) Inventor: Paul Olubummo, (US)

(21) Appl. No.: 16/603,366

(22) PCT Filed: Jun. 5, 2018
(86) PCT No.: PCT/US2018/035966

§ 371 Date: Oct. 7, 2019

(51) Int. Cl. B22F 10/14; B22F 1/00; B22F 12/43; B22F 12/53; B33Y 10/00; B33Y 30/00; B33Y 70/00

(52) U.S. Cl. CPC B22F 10/14; B22F 1/0018; B22F 1/007; B22F 12/43; B22F 2304/10; B33Y 10/00; B33Y 30/00; B33Y 70/00; B22F 1/0014; B22F 12/53

(57) ABSTRACT

A material set can include a binder fluid and a powder bed material. The binder fluid can include an iron oxide nanoparticle, a dispersing ligand, a reducing agent, and an aqueous liquid vehicle. The powder bed material can include from 80 wt % to 100 wt % metal particles that can have a D50 particle size distribution value ranging from 5 μm to 75 μm.

### BACKGROUND

Three-dimensional (3D) printing can involve processes by which a printer transforms materials into a three-dimensional physical object. Designers and manufacturers utilize three-dimensional printing to create prototypes or manufactured usable parts. For example, laboratories utilize three-dimensional printing in tissue engineering research, and the automotive, aviation, and aerospace industries utilize three-dimensional printing for fit and finish checks on parts and to create functional parts, among other uses. Three-dimensional printers come in a wide variety of formats and utilize several processes, e.g., extrusion, photo-polymerization, binding of granular materials, laminating, metal wire processing, continuous liquid interface production, etc.

### BRIEF DESCRIPTION OF THE DRAWINGS

FIG. 1 schematically depicts an example three-dimensional printing system in accordance with the present disclosure;

FIG. 2 is a flow chart illustrating an example method for three-dimensional printing in accordance with the present disclosure;

FIG. 3 schematically depicts an alternative example three-dimensional printing system in accordance with the present disclosure;

FIG. 4 is an example scanning electron microscope (SEM) image illustrating stainless=steel metal particles with an iron oxide containing binder fluid prior to flash heating in accordance with the present disclosure; and

FIG. 5 is an example SEM image illustrating stainless=steel metal particles bound together with an elemental iron after flash heating in accordance with the present disclosure.

### DETAILED DESCRIPTION

Three-dimensional printing can be carried out in one system using metal particles or a powder bed material and selectively ejecting a binder fluid onto portions of the metal particles in a layer by layer manner. By adding additional layers of the metal particles and repeating application of the binder fluid, a three-dimensional green part can be formed. The green part is not typically a finished part and can be heat fused in an oven, sintered, and/or annealed to form the finished part which is harder and sturdier than the intermediate green part or object. With this type of three-dimensional printing, the binder used in the binder fluid is typically a polymer binder. However, polymer binders can fail to provide sufficient mechanical strength to transfer the green part for sintering and/or annealing in some instances. Additionally, polymer binders can decompose at a lower temperature than the temperature upon which the metal particles can become welded or sintered together, resulting in a temperature gap where the green part is held firmly together during heat fusion. This temperature gap can sometimes result in a fall in the mechanical strength of the green part as the polymer is burned off but before the metal particles are sintered together. The fall in mechanical strength can result in a final part that can lack accuracy due to sagging or other malformation that may occur. Moreover, polymer binders can decompose into carbon and contaminate the final part.

Thus, in accordance with the present disclosure, a material set can include a binder fluid and a powder bed material. The binder fluid can include an iron oxide nanoparticle, a dispersing ligand, a reducing agent, and an aqueous liquid vehicle. The powder bed material can include from 80 wt % to 100 wt % metal particles that can have a D50 particle size distribution value from 5 μm to 75 μm. The iron oxide nanoparticle can be any iron oxide, such as iron (II) oxide or iron (III) oxide, but in one example, the iron oxide nanoparticle can be an iron (II) oxide nanoparticle. In one example, the iron oxide nanoparticles can have a D50 particle size distribution value from 10 nm to 1 μm. In another example, the iron oxide nanoparticles can be present in the binder fluid at from 2 wt % to 40 wt %. In one example, the dispersing ligand can include a sulfonic acid or a carboxylic acid. In a more specific example, the dispersing ligand can be selected from 4,5-dihydroxy-1,3-benzendisulfonic acid disodium salt; mercaptoacetic acid; oleic acid; dimecaptosuccinic acid; dopamine; poly(3-O-methacryloyl-α-D-glucopyranose); 3,4-dihydroxyhydrocinnamic acid; 3,4-dihydroxy-L-phenylalanine; 3,4-dihydroxyphenylacetic acid; or a combination thereof. A weight ratio of the iron oxide nanoparticles to the dispersing ligand can range from 1:1 to 5:1 in the binder fluid. The reducing agent, in one example, can be lactic acid, ascorbic acid, ammonia, hydrazine, formaldehyde, sodium borohydride, or a combination thereof. The pH of the binder fluid can range from 7 to 10. The metal particles can be selected from aluminum, titanium, copper, cobalt, chromium, nickel, vanadium, tungsten, tungsten carbide, tantalum, molybdenum, gold, silver, aluminum, stainless=steel, steel, alloys thereof, or admixtures thereof.

In another example, a three-dimensional printing system can include a material set and a fluid ejector. The material set can include a binder fluid and a powder bed material. The binder fluid can include an iron oxide nanoparticle, a dispersing ligand, a reducing agent, and an aqueous liquid vehicle. The powder bed material can include from 80 wt % to 100 wt % metal particles that can have a D50 particle size distribution value from 5 μm to 75 μm. The fluid ejector can deposit the binder fluid onto a selected portion of a layer of the powder bed material. In one example, the fluid ejector can be a thermal fluid ejector.

In another example, a method of three-dimensional printing can include spreading a powder bed material to form a powder layer having a thickness of from 20 μm to 400 μm. The powder bed material includes from 80 wt % to 100 wt % metal particles having a D50 particle size distribution value ranging from 5 μm to 75 μm. The method can also include selectively jetting a binder fluid onto the powder bed material in a pattern corresponding to a layer of a three-dimensional part, and flash heating the layer of the three-dimensional part to a temperature ranging from 200° C. to 1000° C. or photo-chemically reacting the layer of the three-dimensional part or a combination thereof to form a green layer of the three-dimensional part. The binder fluid can include an iron oxide nanoparticle, a dispersing ligand, a reducing agent, and an aqueous liquid vehicle. The method can also include building up additional green layers by sequentially repeating the spreading, the selectively binding, and the flash heating of the powder bed material until a green three-dimensional object is formed. In one example, the method can further include heating the green part so that the metal particles and the iron oxide nanoparticles are sintered or annealed together to form a heat fused part. The flash heating can include irradiating the layer of the powder bed material having the binder fluid jetted thereon with 15 J/cm² to 50 J/cm² of pulsed energy from a pulsed light source positioned at 5 mm to 300 mm away from the layer of the powder bed material.

It is noted that when discussing the material set, the three-dimensional printing system, or the method of three-dimensional printing herein, these descriptions can be considered applicable to one another whether or not they are explicitly discussed in the context of that example. Thus, for example, in discussing a reducing agent related to the material set, such disclosure is also relevant to and directly supported in the context of the three-dimensional printing system, the method of three-dimensional printing and vice versa.

Turning now to the binder fluid, in one example, the binder fluid can include, in addition to the metal oxide nanoparticles and other ingredients, a polymer binder. However, in other examples, the binder fluid can exclude polymeric binder altogether, e.g., the binder fluid can be polymeric binder-free. The term “polymeric binder-free” does not preclude the use of surfactant or other oligomer or small polymers that may be included in the binder fluid as a dispersing agent for nanoparticles (or pigments) or for other purposes related to fluid ejection properties, but rather indicates that binding particles that may be present are not polymers. The binding particles can be iron oxide nanoparticles, for example, that exist at one or more of the various oxidation states. For example, the iron oxide nanoparticles can be an iron (II) oxide, an iron (III) oxide, or a combination thereof. In one example, the iron oxide nanoparticles can be an iron (II) oxide.

The particle size of the iron oxide nanoparticles can vary. As used herein, particle size refers to the value of the diameter of spherical particles or in particles that are not spherical can refer to the longest dimension of that particle. The particle size can be presented as a Gaussian distribution or a Gaussian-like distribution (or normal or normal-like distribution). Gaussian-like distributions are distribution curves that may appear essentially Gaussian in their distribution curve shape, but which can be slightly skewed in one direction or the other (toward the smaller end or toward the larger end of the particle size distribution range). That being stated, an example Gaussian-like distribution of the metal particles can be characterized generally using “D10,” “D50,” and “D90” particle size distribution values, where D10 refers to the particle size at the 10^{th} percentile, D50 refers to the particle size at the 50^{th} percentile, and D90 refers to the particle size at the 90^{th} percentile. For example, a D50 value of 25 μm means that 50% of the particles (by number) have a particle size greater than 25 μm and 50% of the particles have a particle size less than 25 μm. A D10 value of 10 μm means that 10% of the particles are smaller than 10 μm and 90% are larger than 10 μm. A D90 value of 50 μm means that 90% of the particles are smaller than 50 μm and 10% are larger than 50 μm. Particle size distribution values are not necessarily related to Gaussian distribution curves, but in one example of the present disclosure, the metal particles can have a Gaussian distribution, or more typically a Gaussian-like distribution with offset peaks at about D50. In practice, true Gaussian distributions are not typically present, as some skewing can be present, but still, the Gaussian-like distribution can be considered to be essentially referred to as “Gaussian” as used conventionally. In one example, the iron oxide nanoparticles can have a D50 particle distribution value that can range from 10 nm to 1 μm. In yet other examples, the iron oxide nanoparticles can have a D50 particle distribution value that can range from 15 nm to 750 nm or from 20 nm to 400 nm. Iron oxide nanoparticles, in one example, can have a D10 particle distribution value from 5 nm to 200 nm or from 10 nm to 100 nm. The iron oxide nanoparticles, in another example, can have a D90 particle distribution value from 400 nm to 1,000 nm or from 600 nm to 800 nm.

The iron oxide nanoparticles can be present in the binder fluid at from 2 wt % to 40 wt %. In other examples, the iron oxide nanoparticles can be present at from 2 wt % to 20 wt %, from 7 wt % to 30 wt %, or from 10 wt % to 35 wt %, from 2 wt % to 7 wt %, or from 5 wt % to 10 wt %, for example.

The binder fluid can further include a dispersing ligand. The dispersing ligand can exchange surface groups with the iron oxide nanoparticles in order to make the iron oxide nanoparticles dispersible in the aqueous liquid vehicle. In one example, the dispersing ligand can include a sulfonic acid or a carboxylic acid moiety. In other examples, the dispersing ligand can be selected from 4,5-dihydroxy-1,3-benzendisulfonic acid dialkalai metal or ammonium salt (e.g., disodium salt); mercaptoacetic acid; oleic acid; dimercaptosuccinic acid; dopamine; poly(3-O-methacryloyl-α-D-glucopyranose); 3,4-dihydroxyhydrocinnamic acid; 3,4-dihydroxy-L-phenylalanine; 3,4-dihydroxyphenylacetic acid; or a combination thereof. In one example, the dispersing ligand can be selected from mercaptoacetic acid, oleic acid; dimecaptosuccinic acid; carboxylic acid; 3,4-dihydroxyhydrocinnamic acid; 3,4-dihydroxy-L-phenylalanine; 3,4-dihydroxyphenylacetic acid; or a combination thereof. In another example, the dispersing ligand can be 4,5-dihydroxy-1,3-benzendisulfonic acid disodium salt.

The dispersing ligand can be present at an amount to partially cover or cover and/or coat an exterior surface of the iron oxide nanoparticle. For example, a weight ratio of the iron oxide nanoparticles to the dispersing ligand can range from 1:1 to 5:1. In other examples, a weight ratio of the iron oxide nanoparticles to the dispersing ligand can range be from 2:1 to 5:1 or from 3:1 to 4:1. In certain examples, the dispersing ligand can be present in the binder fluid at from 2 wt % to 40 wt %. In yet other examples, the dispersing ligand can be present in the binder fluid at from 4 wt % to 20 wt %, from 7 wt % to 30 wt %, or from 10 wt % to 35 wt %, from 4 wt % to 14 wt %, or from 10 wt % to 20 wt %.

The binder fluid can further include a reducing agent that can be reactive to temperatures above 200° C. In one example, the reducing agent can be an organic acid reducing agent, and in other examples, the reducing agent can be inorganic. A list of example reducing agents include lactic acid, ascorbic acid, ammonia, hydrazine, formaldehyde, sodium borohydride, or a combination thereof. In one example, the reducing agent can be lactic acid, ascorbic acid, or a combination thereof. In another example, the reducing agent can be ammonia, hydrazine, or a combination thereof. The organic acid can be present in the binder fluid at from 0.5 wt % to 10 wt %. In yet other examples, the reducing agent can be present at from 1 wt % to 10 wt %, 0.5 wt % to 5 wt %, from 2 wt % to 8 wt %, or from 2 wt % to 6 wt % in the binder fluid.

The reducing agent can be activated to reduce the iron oxide nanoparticles to elemental iron. The iron oxide nanoparticles in contact with the reducing agent can be stable or relatively unreactive at room temperature (about 25° C.) and can be reduced upon application of heat. In one example, the reduction can occur upon rapid heating up to about 600° C., e.g., heat activation may occur between 250° C. and about 600° C. In another example, the reducing agent can allow this reduction to occur at a lower temperatures, e.g. about 250° C. to about 300° C. The reducing agent can assist in the reduction through the release of reactive moieties, such as hydrogen ion(s), when rapidly exposed to the heat. For example, the reducing agent can provide hydrogen to the oxygen of the iron oxide nanoparticles, completing a redox-reaction at elevated temperatures, where Fe²⁺ gains two electrons (reduction), as shown in Formula I

Fe(II)O+H₂→Fe+H₂O Formula I

Raising the temperature can accelerate this redox-reaction, and in one example, the reducing agent can allow this reduction to occur at a temperature that is below the melting temperature of the iron oxide nanoparticle.

The binder fluid can further include an aqueous liquid vehicle. The aqueous liquid vehicle can include a solvent and in some examples a co-solvent. The aqueous vehicle can be present in the binder fluid at from 20 wt % to 50 wt %, from 25 wt % to 45 wt %, from 30 wt % to 50 wt %, or from 20 wt % to 40 wt %. In one example, the aqueous vehicle can include from 20 wt % to 100 wt % water, from 20 wt % to 95 wt % water, from 30 wt % to 80 wt % water, or from 50 wt % to 80 wt % water. When present, the co-solvent can be selected from 2-pyrrolidone, diethylene glycol, polyethylene glycol, ethylene glycol dimethyl ether, or a combination thereof. The co-solvent can be present in aqueous vehicle at from 10 wt % to 40 wt %.

In some examples, the binder fluid can further include an anitkogation agent. The antikogation agent can be a phosphate surfactant, such as a phosphate ester surfactant. Examples of phosphate ester surfactants include, but are not limited to, surfactants that are commercially available under the EMPHOe or DESOPHOS™ both available from Witco Corp., (Middlebury Conn.), HOSTAPHAr available from Clariant GmbH (Frankfurt, Germany), ESI-TERGE® available from Cook Composites and Polymers Co., (Kansas City, Mo.), EMULGEN® available from Kao Specialties Americas LLC (High Point, Nalco), CRODAFOS™ available from Croda Inc. (Parsippay, N.J.), or DEPHOTROPE™ or DEPHOS™, both available from DeForest Enterprises, Inc. (Boca Raton, Fla.). Specific examples of anionic, nonionic, and amphoteric phosphate ester surfactants can include, but are not limited to, N-3 Acid, EMPHOS® 9NP, EMPHOS® CS121, EMPHOS® CS131, EMPHOS® CS141, EMPHOS® CS1361, HOSTAPHAT® LPKN, ESI-TERGE® 320, ESI-TERGE® 330, DEPHOS™ 8028, EMULGEN® BL-2PK, DESOPHOS™ 4P, DESOPHOS™ 6DNP, DESOPHOS™ 6 MPNA, DESOPHOS™ 6NPNA, DESOPHOS™ 8DNP, DESOPHOS™ 9NP, DESOPHOS™ 10TP, DESOPHOS™ 14DNP, DESOPHOS™ 30NP, or DEPHOTROPE™ CAS-MF. Further examples of phosphate ester surfactants can include oleth-3 phosphate, a nonylphenol ethoxylate phosphate ester, a salt of a nonylphenol ethoxylate phosphate ester, an organophosphate, an aliphatic phosphate ester, a phosphated nonylphenoxy polyethoxy ethanol, or a salt of ethyl-hexanol ethoxylated phosphate ester (“2EH-2EO”). In some examples, mixtures of phosphate ester surfactants can be used. The antikogation agent can be present in the binder fluid at from 5 wt % to 50 wt %. In yet other examples, the antikogation agent can be present at from 10 wt % to 40 wt % or from 15 wt % to 35 wt % in the binder fluid. The antikogation agent can reduce the formation of dried binder fluid on the fluid ejector.

The binder fluid can have a neutral or basic pH. In one example, the binder fluid can have a pH ranging from 7 to 10, or from 7.5 to 9.5. In yet other examples, the binder fluid can have a pH from 8 to 9. If some examples, the binder fluid can include a pH adjuster in order to provide the desired pH range.

Turning now to the powder bed material. The powder bed material can include from 80 wt % to 100 wt % metal particle, from 90 wt % to 100 wt % metal particle, from 99 wt % to 100 wt % metal particle, or can consist of the metal particle, e.g., 100 wt % metal particles. The metal particles can be of an elemental metal, such as elemental transition metals. Examples can include titanium, copper, cobalt, chromium, nickel, vanadium, tungsten, tungsten carbide, tantalum, molybdenum, gold, silver, etc. The metal particles can also be aluminum (which is not a transition metal), or it can be an alloy of multiple metals or can include a metalloid(s). In some examples, the alloy can be steel or stainless=steel. Even though steel includes carbon, it is still considered to be metal in accordance with examples of the present disclosure because of its metal-like properties. The metal particles can be an admixture of any of these materials. In one example, the metal particles can be aluminum, titanium, copper, cobalt, chromium, nickel, vanadium, tungsten, tungsten carbide, tantalum, molybdenum, gold, silver, aluminum, stainless=steel, steel, alloys thereof, or an admixture thereof.

The metal particles can exhibit good flowability and can have a shape type that can be spherical, irregular spherical, rounded, semi-rounded, discoidal, angular, subangular, cubic, cylindrical, or any combination thereof, to name a few. In one example, the metal particles can include spherical particles, irregular spherical particles, rounded particles, or other particle shapes that have an aspect ratio from 1.5:1 to 1:1, from 1.2:1, to 1:1. In some examples, the shape of the metal particles can be uniform or substantially uniform, which can allow for relatively uniform melting or sintering of the particulates after the three-dimensional green part is formed and then heat fused in a sintering or annealing oven, for example.

The particle size distribution can also vary. In accordance with this, in one example, the metal particles can have a D50 particle size distribution value that can range from 5 μm to 75 μm, from 10 μm to 60 μm, or from 20 μm to 50 μm. In other examples, the metal particles can have a D10 particle size distribution value can range from 1 μm to 50 μm or from 5 μm to 30 μm. In another example, of the D90 particle size distribution value can range from 10 μm to 100 μm or from 25 μm to 80 μm.

The metal particles can be produced using any manufacturing method. However, in one example, the metal particles can be manufactured by a gas atomization process. During gas atomization, a molten metal is atomized by inert gas jets into fine metal droplets that cool while falling in an atomizing tower. Gas atomization can allow for the formation of mostly spherical particles. In another example, the metal particles can be manufactured by a liquid atomization process.

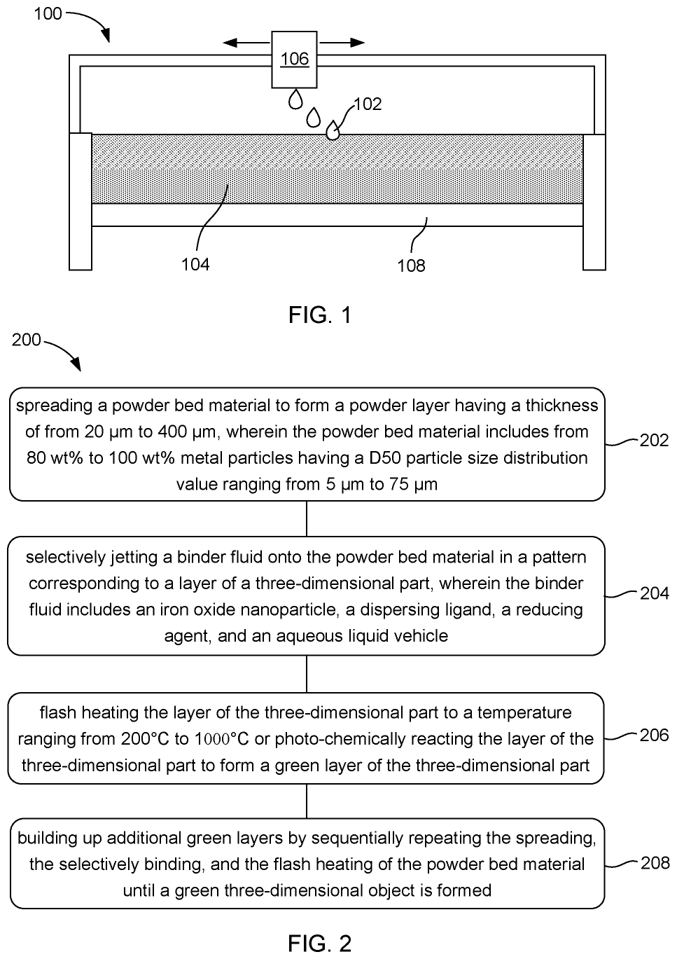

In further detail, a three-dimensional printing system and method of three-dimensional printing is disclosed herein that can be implemented with the material sets disclosed herein. To provide an example of a three-dimensional printing system by way of illustration, FIG. 1 depicts a three-dimensional printing system 100 that can include a material set 102, 104, fluid ejector 106, and a powder bed support 108. The material set can include a binder fluid 102 and a powder bed material 104. The fluid ejector can deposit the binder fluid onto a selected portion of the powder bed material. The fluid ejector can be a thermal fluid ejector, in one example.

In another example, a method 200 of three-dimensional printing, as shown in a flow diagram of FIG. 2, can include a spreading 202 a powder bed material to form a powder layer having a thickness of from 20 μm to 400 μm. The powder bed material includes from 80 wt % to 100 wt % metal particles having a D50 particle size distribution value ranging from 5 μm to 75 μm. The method can also include selectively jetting 204 a binder fluid onto the powder bed material in a pattern corresponding to a layer of a three-dimensional part, and flash heating 206 the layer of the three-dimensional part to a temperature ranging from 200° C. to 1000° C. or photo-chemically reacting the layer of the three-dimensional part to form a green layer of the three-dimensional part. In some examples, flash heating can also include photochemical reacting as part of a common procedure. The binder fluid can include an iron oxide nanoparticle, a dispersing ligand, a reducing agent, and an aqueous liquid vehicle. The method can also include building up 208 additional green layers by sequentially repeating the spreading, the selectively binding, and the flash heating or photo-chemically reacting of the powder bed material until a green three-dimensional object is formed. In some examples, the method can include flash heating and a photo-chemical reaction. In one example, the method can further include heating the green part so that the metal particles and the iron oxide nanoparticles are sintered or annealed together to form a heat fused part.

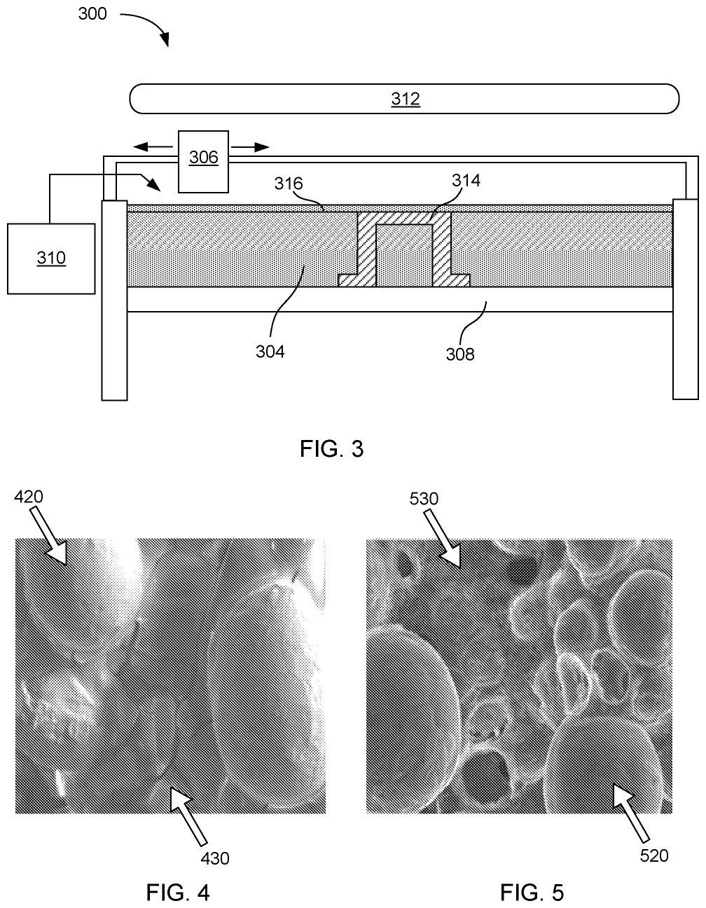

In further detail, a three-dimensional printing system 300 is shown, which can illustrate additional details regarding the system as well as further aspects of the method of three-dimensional printing. As shown in FIG. 3, a layer 316 of the powder bed material 304 can be deposited and spread out from a powder bed material source 310, typically evenly at a top surface of a substrate, which can be a support or powder bed support 308 or container (when spreading the first layer) or can be a previously deposited powder bed material layer which can include a portion of a green part or object that is being built (as shown in FIG. 3). The binder fluid can then be selectively printed from a fluid ejector 306 on a portion of the powder bed material in a pattern corresponding to a layer of the three-dimensional part 314 to be printed. The binder fluid can wet the powder bed material and/or wet and flow along a surface of the powder bed material to agglomerate between adjacent particles. The layer of the three-dimensional part can be flash-heated using a pulsed light source 312, for example and/or photo-chemically reacted using irradiation energy. The location of the binder fluid can dictate the location of metallic binding after flash heating and/or photo-chemically reacting. The powder bed support can be dropped down on a layer by layer basis following the formation of the various layers to allow for the formation of subsequent layers of the three-dimensional part to be built on top of one another. The powder bed material can support subsequent layers of the three-dimensional part. In some examples, the method can include repeating the layering, the selectively jetting, and the flash heating or photo-chemically reacting to form a subsequent layer over the layer of the three-dimensional part until a green part is formed. Flash heating, pulse thermal processing, and/or photo-chemically reacting with irradiation energy can allow for increased mechanical strength of printed three-dimensional parts. The mechanical strength can be sufficient to handle the part without damage, e.g., picking up the part, inspecting the part, moving the part to an annealing or sintering oven, etc. In another example, the method can include heating the green part so that the metal particles and the iron oxide nanoparticles are sintered or annealed together to form a heat fused part.

In further detail, the layer of powder bed material can have a thickness that can range from 25 μm to 400 μm, from 75 μm to 400 μm, from 100 μm to 400 μm, 150 μm to 350 μm, or from 200 μm to 350 μm. The thickness of the layer can be determined in part based on the powder bed material particle size or particle size distribution, e.g., D50 particle size, the desired resolution of the printed part, and/or the amount of thermally sensitive binder fluid applied to an uppermost surface of the powder bed material layer at the individual build layer, etc.

The selective jetting of the binder fluid from the fluid ejector can occur at a relatively low temperature (temperature typically below 200° C.). Ejecting the binder fluid at a temperature greater than 100° C. can provide some removal (evaporation) of volatile liquid components from the binder fluid prior to flash heating and/or photo-chemically reacting the layer.

The flash heating can be a pulse of light, optical energy, or any other heat source operable to rapidly raise the temperature (e.g., usually above about 200° C.) of the layer of the powder bed material having the binder fluid printed thereon to initiate a thermally activated redox-reaction between the iron oxide nanoparticles and the reducing agent (now held within the layer of powder bed material). Photo-chemically reacting can induce a redox-reaction by exciting electrons on the iron oxide nanoparticles and/or reducing agent. Volatile byproducts not already removed during selectively ejecting the binder fluid can be further removed at this even higher temperature. The redox-reaction between the iron oxide nanoparticles and the reducing agent can result in pure iron.

Iron Oxide Nanoparticles+Reducing Agent+Flash Heating and/or Photo-chemically Reacting→

Iron Oxide Nanoparticles+Reactive Moieties from Flash Heating-decomposed Reducing Agent or Transient Reactive Moieties from Photo-chemically Reacting Reducing Agent→

Pure Iron+Volatile Products from Reaction between Iron Oxide Nanoparticles and Reactive Moieties.

The term “pulse” heating or “flash” heating (or fusion) can refer to raising a temperature of a surface layer of a powder bed material with a binder fluid printed thereon. Flash heating can have little to no impact on an underlying part layer of the printed object. In yet other examples, flash heating can have some impact on lower layers, depending on the material and the layer thickness. The very short heating durations can reduce thermal stresses, which can ameliorate potential breaking of newly formed bonds between adjacent metal particles of the powder bed material, while at the same time, reducing energy and printing costs.

Example pulse energies that can be irradiated can range from 15 J/cm² to 50 J/cm² and can be from a pulsed light source or heat source that can be positioned at from 5 mm to 300 mm away from the powder bed material. In yet other examples, the pulsed light source or other heat source can irradiate from 20 J/cm² to 40 J/cm² of energy onto the powder bed material. In other examples, the light source or heat source can be positioned at from 25 mm to 125 mm, from 75 mm to 300 mm, from 30 mm to 70 mm, from 10 mm to 20 mm, from 25 mm to 300 mm, or from 150 mm to 250 mm away from the powder bed material during operation.

The light source can be a non-coherent light source such as a pulsed gas discharge lamp or a xenon pulse lamp. It can be noted that pulsing the light energy (or flash heating) can be based on a single pulse or repeated pulses as may be designed for a specific application to advance or even complete the redox reaction. To illustrate, a higher energy single pulse may be enough to cause a fast-redox reaction to occur, or multiple lower energy pulses can likewise be used if a slower redox reaction may be desired (per layer), e.g., from 2 to 1,000 pulses, from 2 to 100 pulses, from 2 to 20 pulses, from 5 to 1,000 pulses, from 5 to 100 pulses, etc. In some examples, repeated pulses can be used in order to reduce the iron oxide nanoparticles.

In some examples, after flash heating and prior to applying the next layer of powder bed material, a subsequent layer of binder fluid can be applied to the powder bed material having the binder fluid previously applied thereto (either with or without flash heating). This subsequent layering of binder fluid can provide additional inter-layer adhesion strength.

The term “photo-chemically” reacting refers to application of one or more wavelength of light energy, such as UV, visible, IR energy, etc., to cause a reaction to occur. For example, the flash heating process may be used with materials that also have properties susceptible to photo-chemical initiation or reaction. In certain examples where there may be a small amount of polymer or pre-polymer material used with the iron oxide nanoparticles, polymerization may be initiated or furthered by the application of photo energy.

It is noted that, as used in this specification and the appended claims, the singular forms “a,” “an,” and “the” include plural referents unless the content clearly dictates otherwise.

As used herein, “aspect ratio” refers to an average of the aspect ratio of the collective particles as measured on the individual particle by the longest dimension in one direction and the longest dimension in a perpendicular direction to the measured dimension.

“Particle size” refers to the diameter of spherical particles, or to the longest dimension of non-spherical particles. Particle size is provided herein based on a sample of a plurality of metal particles or iron oxide nanoparticles, for example, using D10, D50, and/or D90 particle size distributions.

As used herein, a binder fluid that provides “selective” binding of a powder bed material refers to a property of a fluid that when applied to the powder bed material and activated by heat and/or light, can assist in binding metal particles together. The selective binding can include selecting a portion of a top layer of powder bed material, or even all (or none) of a top layer or a powder bed material, during a three-dimensional build in accordance with the present disclosure.

As used herein, a plurality of items, structural elements, compositional elements, and/or materials may be presented in a common list for convenience. However, these lists should be construed as though the members of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range but also to include all the individual numerical values or sub-ranges encompassed within that range as if the numerical values and sub-ranges are explicitly recited. For example, a weight ratio range of 1 wt % to 20 wt % should be interpreted to include not only the explicitly recited limits of 1 wt % and 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following illustrates examples of the present disclosure. However, it is to be understood that the following is only illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1—Binder Fluid

Iron oxide nanoparticles were milled using zirconium oxide beads in the presence of excess tiron (4,5-dihydroxy-1,3-bemzenedisulfonic acid disodium salt monohydrate) for 1 hour in a milling machine. The tiron can exchange surface groups on the iron oxide nanoparticles (IONP), in one example, as shown in Formula II.

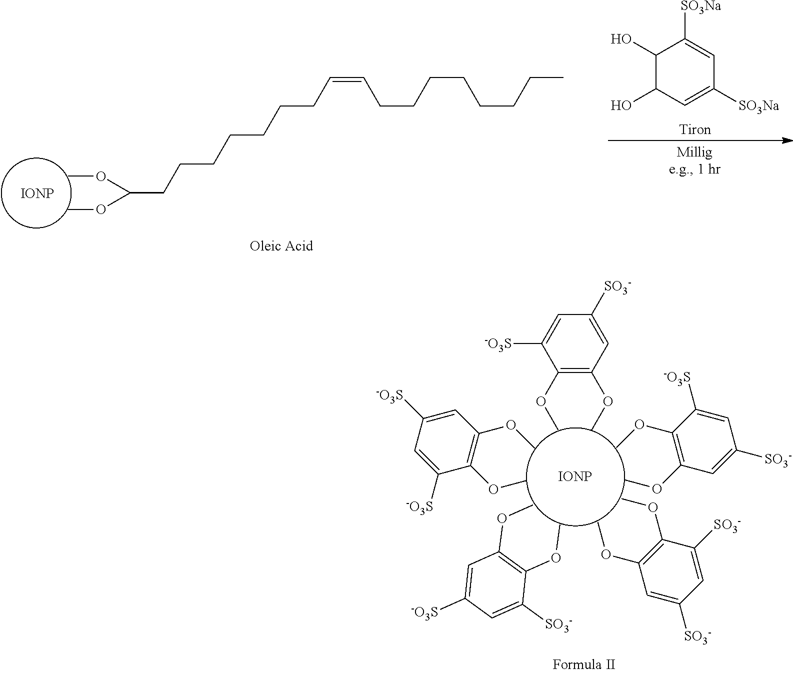

The tiron coated nanoparticles were then filtered. The filtered tiron coated nanoparticles were then admixed with a formulation of an aqueous vehicle including water and ethylene glycol.

### Example 2—Three-Dimensional Printing

The binder fluid from Example 1 was ejected using an HP thermal jet depositing ejector at 0.2 mL/cm² onto a powder bed material of 100 wt % stainless=steel (SS) particles having a D50 particle size of 25 μm. The single printed layer was rapidly heated with a commercial Xenon strobe lamp with one 10 ms irradiation pulse, e.g., 26 J/cm², capable of raising the temperature of the powder bed material to about 400° C. to 500° C.

SEM images were taken before (FIG. 4) and after (FIG. 5) flash heating of the stainless=steel metal particles and binder fluid using a scanning electron microscope at 2,000 times magnification. More specifically, as can be seen in FIG. 4, the binder fluid including iron oxide nanoparticles 430 are shown as filling interstitial regions between the stainless=steel particles 420 of the powder bed material rather than becoming coated on the stainless=steel particles. FIG. 5, on the other hand, shows that after flash heating, volatiles or other ingredients of the binder fluid, other than primarily the iron oxide particles remain with the sintered metal object after partial reduction of the iron oxide nanoparticles to form elemental iron. FIG. 5 additionally shows bonding between the iron nanoparticles 530 and the stainless=steel powder bed material 520.

The chemical composition of the printed powder bed material was analyzed using energy-dispersive X-ray spectroscopy before and after pulse irradiation. The chemical composition of the stainless=steel particles and the interstitial regions is shown in Table 1, below.

TABLE 1
Chemical Composition

| | | Fe | Cr | Ni | O | C | S | Na |
|---|---|---|---|---|---|---|---|---|
| Before | SS | 57 | 17 | 11 | 2 | 12 | 0.5 | 0.5 |
| Pulse | particle | | | | | | | |
| Irradiation | Interstitial | 30 | 1 | 0.5 | 14 | 20 | 26 | 8.5 |
| | Region | | | | | | | |
| After | SS | 58 | 18 | 11 | 2 | 10 | 0.5 | 0.5 |
| Pulse | particle | | | | | | | |
| Irradiation | Interstitial | 60 | 1 | 1 | 8 | 17 | 6 | 7 |
| | Region | | | | | | | |

The iron oxide nanoparticles in the binder fluid for three-dimensional printing provided mechanical strength to a green part and eliminated binder burn off. The single printed layer of powder bed material (SS) that was spread out and bound together by the binder fluid of this example was mechanically strong enough to be lifted out of the powder bed and manipulated prior to being heat fused as a final part.

What is claimed is:

1. A material set, comprising:
a binder fluid, including:
iron oxide nanoparticles,
a dispersing ligand,
a reducing agent, and
an aqueous liquid vehicle; and
a powder bed material, including from 80 wt % to 100 wt % metal particles having a D50 particle size distribution value from 5 μm to 75 μm.

2. The material set of claim 1, wherein the iron oxide nanoparticles include iron (II) oxide nanoparticles.

3. The material set of claim 1, wherein the iron oxide nanoparticles have a D50 particle size distribution value from 10 nm to 1 μm.

4. The material set of claim 1, wherein the iron oxide nanoparticles are present in the binder fluid at from 2 wt % to 40 wt %.

5. The material set of claim 1, wherein the dispersing ligand includes a sulfonic acid or a carboxylic acid.

6. The material set of claim 1, wherein the dispersing ligand is 4,5-dihydroxy-1,3-benzendisulfonic acid disodium salt; mercaptoacetic acid; oleic acid; dimecaptosuccinic acid; dopamine; poly(3-O-methacryloyl-α-D-glucopyranose); 3,4-dihydroxyhydrocinnamic acid; 3,4-dihydroxy-L-phenylalanine; 3,4-dihydroxyphenylacetic acid; or a combination thereof.

7. The material set of claim 1, wherein the iron oxide nanoparticles and the dispersing ligand are present in the binder fluid at a weight ratio of 1:1 to 5:1.

8. The material set of claim 1, wherein the reducing agent is lactic acid, ascorbic acid, ammonia, hydrazine, formaldehyde, sodium borohydride, or a combination thereof.

9. The material set of claim 1, wherein a pH of the binder fluid ranges from 7 to 10.

10. The material set of claim 1, wherein the metal particles is selected from aluminum, titanium, copper, cobalt, chromium, nickel, vanadium, tungsten, tungsten carbide, tantalum, molybdenum, gold, silver, aluminum, stainless=steel, steel, alloys thereof, or admixtures thereof.

11. A three-dimensional printing system, comprising:
a material set, including:
a binder fluid, including:
an iron oxide nanoparticle,
a dispersing ligand,
a reducing agent, and
an aqueous liquid vehicle; and
a powder bed material, including from 80 wt % to 100 wt % metal particles having a D50 particle size distribution value from 5 μm to 75 μm; and
a fluid ejector to deposit the binder fluid onto a selected portion of a layer of the powder bed material.

12. The three-dimensional printing system of claim 11, wherein the fluid ejector is a thermal fluid ejector.

13. A method of three-dimensional printing, comprising:
spreading a powder bed material to form a powder layer having a thickness of from 20 μm to 400 μm, wherein the powder bed material includes from 80 wt % to 100 wt % metal particles having a D50 particle size distribution value ranging from 5 μm to 75 μm;
selectively jetting a binder fluid onto the powder bed material in a pattern corresponding to a layer of a three-dimensional part, wherein the binder fluid includes:
an iron oxide nanoparticle,
a dispersing ligand,
a reducing agent, and
an aqueous liquid vehicle;
flash heating the layer of the three-dimensional part to a temperature ranging from 200° C. to 1000° C. or photo-chemically reacting the layer of the three-dimensional part to form a green layer of the three-dimensional part; and
building up additional green layers by sequentially repeating the spreading, the selectively binding, and the flash heating of the powder bed material until a green three-dimensional object is formed.

14. The method of claim 13, further comprising heating the green part so that the metal particles and the iron oxide nanoparticles are sintered or annealed together to form a heat fused part.

15. The method of claim 13, wherein the flash heating includes irradiating the layer of the powder bed material having the binder fluid jetted thereon with 15 J/cm² to 50 J/cm² of pulsed energy from a pulsed light source positioned at 5 mm to 300 mm away from the layer of the powder bed material.
